(19) United States
(12) Patent Application Publication
(10) Pub. No.: US 2014/0097202 A1
(43) Pub. Date: Apr. 10, 2014

(54) Support Unit

(71) Applicant: Joergen Knudsen, Struer (DK)

(72) Inventor: Joergen Knudsen, Struer (DK)

(21) Appl. No.: 14/105,316

(22) Filed: Dec. 13, 2013

Related U.S. Application Data
(62) Division of application No. 13/456,526, filed on Apr. 26, 2012.

(30) Foreign Application Priority Data
Nov. 5, 2009 (DK) PA 2009 01189
Jul. 1, 2010 (DK) PA 2010 00580

(51) Int. Cl. B67D 3/00

(52) U.S. Cl. CPC B67D 3/008
USPC 222/105

(57) ABSTRACT

A support unit for supporting a drain tap in a flexible bag located in a bag-in-box (BIB) liquid dispenser includes a substantially planar plate with a least one surface adapted to abut the outer surface of the box. The support unit has a slit to receive the drain tap when lead through the wall of the box and form a supporting collar around the drain tap where the plate area next to the slit tapers towards the opening of the slit, forming two tapering areas on each side of the slit. The support unit may further include an area that is convex.

### SUPPORT UNIT

This application is a Divisional of, and claims priority under 35 U.S.C. §120 to, U.S. patent application Ser. No. 13/456,526, filed 26 Apr. 2012, which was a Continuation of, and claims priority under 35 U.S.C. §120 to, International Application No. PCT/DK2010/000143, filed 3 Nov. 2010, and claims priority therethrough to Danish Application Nos. PA 2009 01189, filed 5 Nov. 2009, and PA 2010 00580, filed 1 Jul. 2010, the entireties of which are incorporated by reference herein.

### BACKGROUND

1. Field of Endeavor

The present invention relates to a support unit for supporting a drain tap in a flexible bag located in a bag in box (BIB) liquid dispenser. The invention relates also to the use of the support unit.

2. Brief Description of the Related Art

Liquid dispensers such as, e.g., cardboard boxes for wine with a drain tap, often referred to as BIB (bag in box), are used in a still-increasing extent. This results from the fact that these kinds of containers have many positive characteristics, including that the liquid, e.g., the wine, can be drained off in portions without oxygen supply, since the wine is kept in an airtight plastic bag inside the outer container or box, which is mostly manufactured from cardboard.

The fact that no oxygen is added to the liquid, which is being drained off, means that this form of packaging is appropriate for consumers who only want a single glass of wine for dinner. Traditional wine bottles of glass are not appropriate for such a pattern of use, as the quality of the wine quickly changes, when the wine bottle is opened. By draining wine off from an airtight plastic bag with a drain tap in a cardboard box, the wine will keep its quality for a long time, which is obviously an advantage, if only a single glass or a few glasses of wine are drained off each day.

It has been found, however, that there are some drawbacks connected to the handling of liquid dispensers in the shape of, e.g., a bag in cardboard boxes with a drain tap.

When the wine or other beverage is to be consumed, the tap valve is lead though an opening in the box. The box has normally been prepared for this opening by weakened lines for tearing the cardboard open to allow the tubular-shaped drain tap to pass through the wall of the box. When the drain tap is lead through the wall of the box, it is only supported by the cardboard, which may be relatively thin and soft. This weak support has the effect that the tap valve may be difficult to operate in particular with one hand, which is often necessary when the wine or other beverage has to be drained into a glass by a person.

Several attempts to solve this problem have been made. European patent application EP 0884269 discloses a device for dispensing liquids from bag-in-boxes provided with a drain tap, which includes a base for accommodating and supporting at least one bag-in-box. The device further includes two half-circular retention devices which are meant to detachably engage a portion of the drain tap in order to rigidly couple the bag-in-box to the seating and supporting base and to support the drain tap in the bag-in-box.

U.S. Pat. No. 3,696,969, disclosing a beverage dispensing system, describes an embodiment where a reinforcing collar is inserted to support the tap. The reinforcing collar is made from a flat piece of plastic or metal with a slit to engage with the tap.

Although the known supporting devices may function very well as such, they are either relatively complicated to manufacture and use or they are difficult to mount and optionally remove for reuse due to poor gripping properties. The latter is particularly true for the flat type of support which, moreover, may suffer from the drawback that they are easy to break, in particular if they are made from a plastic material.

### SUMMARY

Consequently, one of numerous aspects of the present invention includes a support unit for supporting a drain tap in a bag in a bag-in-box dispensing system, which support unit is easy and simple to use and mount on a drain tap from a bag in box, and provides a good grip for mounting and removing the support unit.

Moreover, another object includes a support unit for supporting a drain tap in a bag in a bag-in-box dispensing system, which support unit has an excellent strength and durability, and can be reused several times.

Thus, in another aspect, in a support unit for supporting a drain tap in a flexible bag located in a bag-in-box (BIB) liquid dispenser, the support unit comprises a plate having at least a substantially planar area with a least one surface adapted to abut the outer surface of the box and the support unit further comprises a slit to receive the drain tap when lead through the wall of the box and forms a supporting collar around the drain tap, where the plate area next to the slit is tapering towards the opening of the slit thereby forming two tapering areas on each side of the slit.

The support unit is particularly suitable for supporting the drain tap mounted on a flexible plastic bag in a box, which drain tap is equipped with a flange to engage with and press against the wall of the box. Normally, the drain tap on a bag-in-box dispensing device is substantially tubular shaped and located in the lower part of the bag-in-box to allow emptying of the bag by the influence of gravity. The drain tap comprises a valve preferably a check-valve.

A support unit embodying principles of the present invention is equipped with a slit to engage with the drain tap and, moreover, comprises an area with a substantially flat side which can abut the outer surface of the box. The opposite side of the support unit is adapted to abut with the side of the flange on the drain tap that faces the outer surface of the box. In this manner the support unit provides a tension between the flange and the outer surface of the box which again results in an excellent support of the drain tap where a least a part of the support unit forms a supporting collar around the drain tap. The size of the slit is selected to fit with the size of regular tubular drain tap. Typically, the width of the slit is in the range of 1 to 5 cm. Moreover, the thickness of the support unit is selected to fit between the outer wall of the box and the flange of the drain tap, preferably the thickness is in the range of 1 to 5 mm.

If the drain tap has no flange, the slit of the support unit is adapted engage with the drain tap by the action of friction and thereby provide a support of the drain tap.

An advantage of the support unit is that the plate area next to the slit tapers towards the opening of the slit, thereby forming two tapering areas or zones on each side of the slit. The plate area is preferably tapering symmetrical on both sides of the slit, thereby forming two tapering areas which may be symmetrical on each side of the slit. The tapering facilitates the mounting of the support unit on the drain tap and also serves to reduce the material used for producing the support unit.

Although the support unit may have any desired shape, it is preferred that at least a part of the outer edge of the support unit is curved. A support unit with a curved edge may require less material for production and still have sufficient strength. A curved edge also improves the grip on the support unit when it is removed from the bag-in-box liquid dispenser. In an embodiment, the support unit has an approximately circular shaped edge. A circular shape optimizes the material consumption and at the same time provides good strength to the support unit. When the support unit has a circular shape, the average diameter of the support unit is preferably in the range of 5 to 15 cm.

When the support unit has a substantially circular shape, the U-shaped slit is preferably located in the plate in such a way that the center of the tubular drain tap will also constitute the center of the circle formed by the outer edge of the support unit. In this way the drain tap mounted with the support unit will have an esthetic and harmonious appearance.

In a further aspect, in a support unit for supporting a drain tap in a flexible bag located in a bag-in-box (BIB) liquid dispenser, the support unit comprises at least one area with a substantially flat surface to abut the outer surface of the box at the location where the drain tap is lead through the wall of the box, the support unit further comprises a slit to receive the drain tap when lead through the wall of the box and form a supporting collar around the drain tap, wherein the support unit comprises at least one convex area.

To improve the strength of the support unit, the support unit comprises at least one convex area. The convex area forming a bulge in the support unit also improves the gripping properties of the support unit. In this way at least two advantages are achieved, namely, a support unit for a bag-in-box liquid dispenser, which support unit has improved strength and is easier to mount and remove due to better gripping properties.

To obtain the best possible properties of the support unit, the slit has a rounded part adapted to engage with the drain tap. Preferably the slit is U-shaped, which provides an excellent fit for the tubular shaped drain tap.

For the purpose of achieving a good support of the drain tap, it is desirable that at least a part of the area with a substantially flat surface surrounds the slit. Such embodiments allow the support unit to engage with the outer wall of the box and a flange on the drain tap and provide tension between the outer surface of the wall and the flange, whereby excellent support of the drain tap is achieved.

If the drain tap has no flange, the slit of the support unit is adapted to provide friction between the engaging surfaces of the support unit and the drain tap. This friction will maintain the support unit on the drain tap and allows the support unit to support the drain tap.

To improve the properties of the support unit, it is preferred that at least a part of the area with a substantially flat surface is U-shaped and surrounds the U-shaped slit to obtain good engagement with the tubular shaped drain tap.

In an embodiment of the support unit, the at least one convex area extends around the slit. In this manner the strength of the support unit is improved significantly. In a preferred embodiment the at least one convex area extends around at least a part of the area with a substantially flat surface and the slit. This embodiment provides good strength in combination with good supporting properties.

For the purpose of further improving the properties of the support unit, the periphery of the support unit is adapted to abut the outer surface of the box. Thus, the periphery of the support has a flat surface adapted to abut the outer surface of the box to improve the support of the drain tap.

In a preferred embodiment, the support unit has a substantially circular periphery. A substantially circular periphery facilitates the placing of the support unit on the drain tap as the “corner free” support unit is easy to place on the outer surface of the box.

To further improve the strength of the support unit, an embodiment includes at least a part of the convex area with supporting ridges. One or more ridges in the convex area significantly increase the strength and the rigidity of the support unit.

Although the support unit may be made from several types of material, it is preferred that the support unit is made from a rigid or semi-rigid material selected from plastic, aluminum and stainless steel. When the support unit is made from plastic it may be ABS, polyethylene, polystyrene, etc. The support unit may be manufactured in various colors and shapes to fit with drain taps of various bag-in-box (BIB) liquid dispensers.

Another aspect includes the use of a support unit as described above for supporting a drain tap in a flexible bag located in a bag-in-box (BIB) liquid dispenser.

The use includes embodiments where the surface of the support unit is equipped with a print or logo. Such use may be a commercial and marketing use where the support unit may have a company name and/or logo printed on the surface and optionally delivered with a bag in box for beverage dispensing.

### BRIEF DESCRIPTION OF THE DRAWINGS

The invention will now be described in further detail with reference to drawings where,

FIG. 1 shows an embodiment of a support unit according to the invention,

FIG. 2 shows a different embodiment of a support unit according to the invention,

FIG. 3 shows an embodiment of a support unit with a convex area according to the invention,

FIG. 4 shows another embodiment of a support unit with a convex area according to the invention,

FIG. 5 shows an embodiment of a support unit in FIG. 4 seen from the other side,

FIG. 6 shows an embodiment of a support unit with ridges according to the invention,

FIG. 7 shows a cross-section of a bag in box with drain tap,

FIG. 8 shows the cross- section of FIG. 7 with a support unit according to the invention mounted on the drain tap, and

FIG. 9 shows a bag-in-box unit with a support unit according to the invention mounted on the drain tap.

### DETAILED DESCRIPTION OF EXEMPLARY EMBODIMENTS

In the following, a support unit according to principles of the present invention will be described with reference to some preferred embodiments. The reference numbers used will be the same for the same parts and, consequently, refer to the same parts of the support units shown in the drawings.

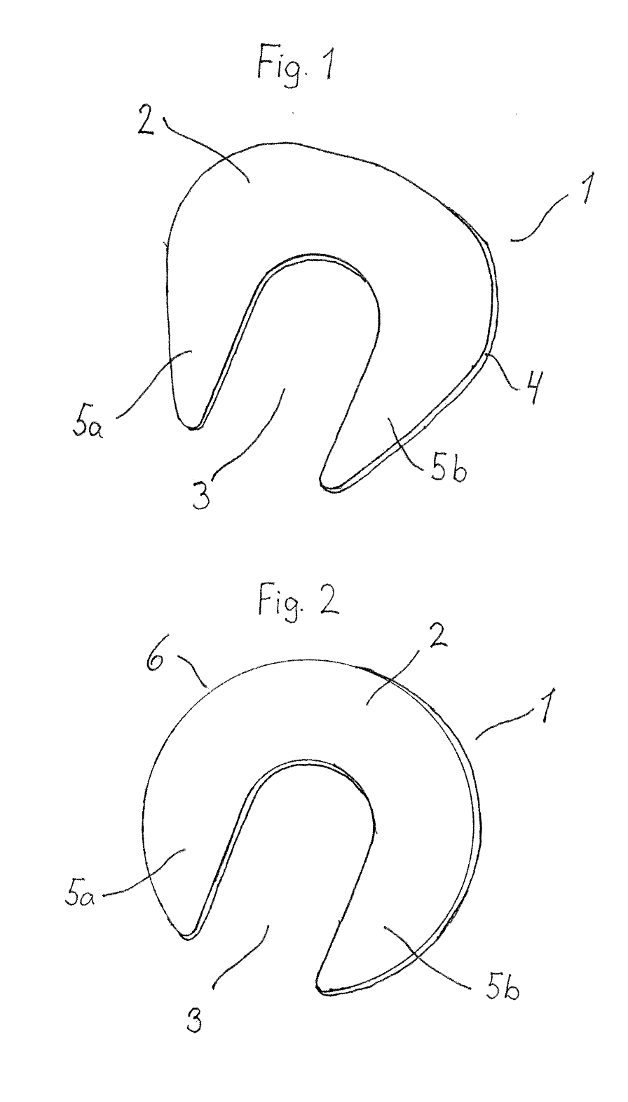

FIG. 1 shows an embodiment of a support unit 1 according to principles of the present invention. The support unit 1 includes a planar plate piece 2 having a slit 3 to receive a drain tap from a bag-in-box liquid dispenser. The slit 3 is U-shaped, as the U-shape allows the support unit 1 to fit with a tubular shaped drain tap and optionally provide friction between the engaging surface of the drain tap and the U-shaped slit.

The plate piece 2 constituting the support unit 1 has a thickness 4 which is adapted to fit between a flange on the drain tap and the outer surface of the wall of a bag in box. The plate piece 2 tapers towards the opening of the slit 3 thereby forming two tapering areas or zones 5a and 5b. The two tapering zones 5a and 5b are symmetrical and mutually reversed. The tapering zones 5a and 5b facilitates the mounting of the support unit on a drain tap from a bag in box liquid dispenser.

FIG. 2 shows an alternative embodiment of a support unit 1 according to principles of the present invention. The planar plate piece 2 has a substantially circular outer edge 6 except from the area of the slit 3. Due to the circular shape of the support unit 1, each of the tapering zones 5a and 5b have a curved edge which is part of the outer edge 6.

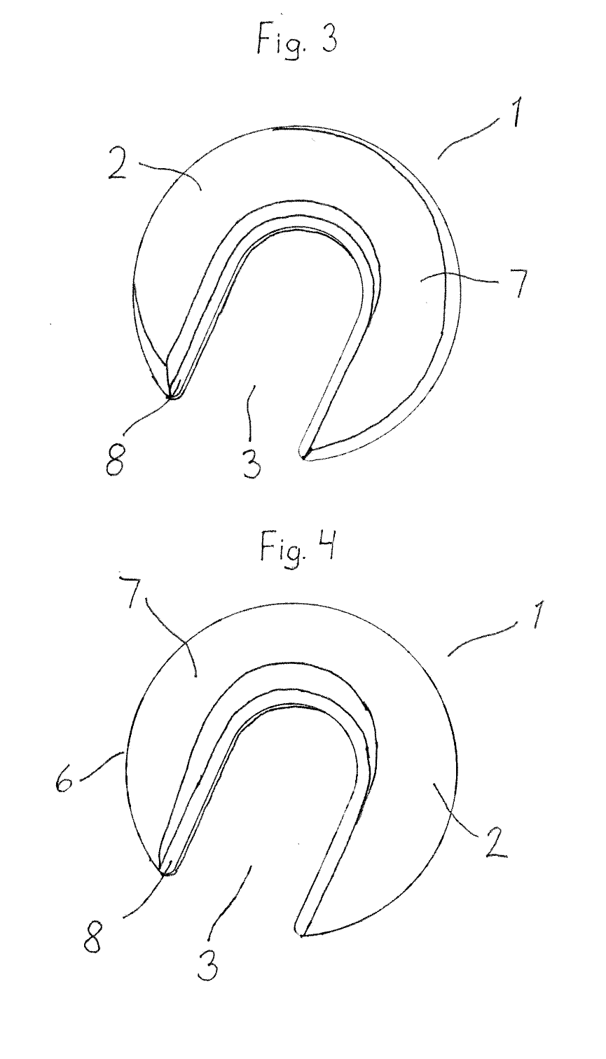

In FIG. 3 is seen a support unit 1 having a convex area 7. The convex area 7 is formed in the plate piece 2. A substantially planar U-shaped part 8 surrounds the U-shaped slit 3. The U-shaped part 8 is intended to be located between the flange on a drain tap and the outer wall of a bag-in-box liquid dispenser.

FIG. 4 shows a support unit 1 having a convex area 7. The convex area 7 is formed in the plate piece 2 and has a more gradual transition from the outer edge 6 than the convex area 7 of the embodiment shown in FIG. 3. A substantially planar U-shaped part 8 surrounds the U-shaped slit 3. The U-shaped part 8 is intended to be located between the flange on a drain tap and the outer wall of a bag-in-box liquid dispenser.

FIG. 5 shows the support unit 1 of FIG. 4 seen from the back side, i.e., the side intended for facing the outer wall of a bag in box liquid dispenser. The convex area 7 is located between the outer edge 6 and the U-shaped part 8 surrounding the slit 3. The U-shaped part 8 and the outer edge 6 have a flat surface 9 for abutment with the outer wall of a bag-in-box liquid dispenser.

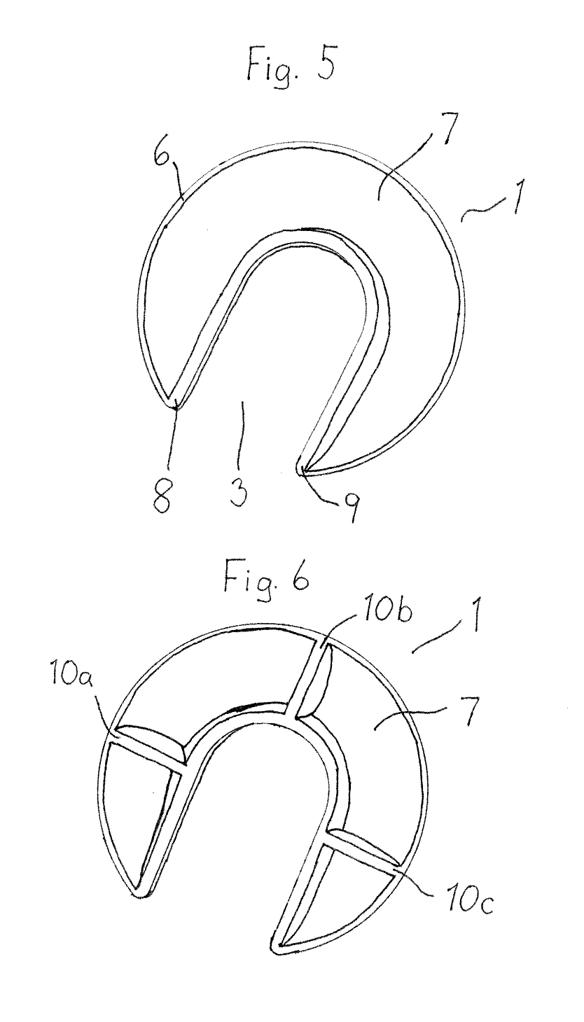

FIG. 6 shows a support unit 1 corresponding to the support unit shown in FIG. 5 where the convex area 7 is equipped with ridges 10a, 10b and 10c. The ridges 10a, 10b and 10c improve the strength of the support unit 1.

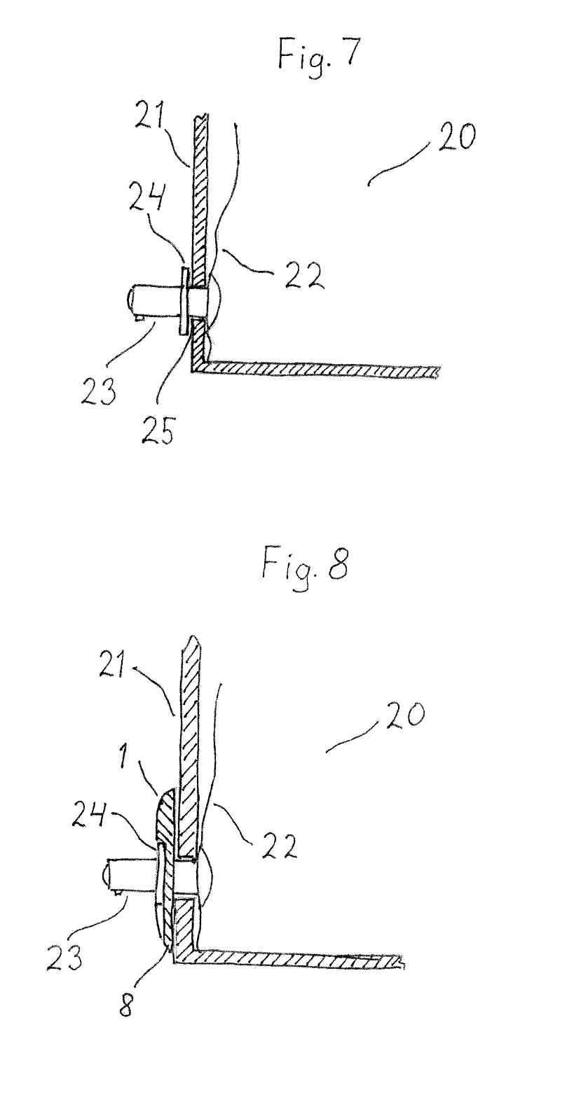

FIG. 7 shows a part of a cross-section of a bag-in-box liquid dispenser 20. The bag-in-box liquid dispenser 20 includes a wall 21 of cardboard. The liquid dispenser 20 contains a bag 22 having a drain tap 23 with a flange 24 attached at the lower part. The drain tap 23 is lead through an opening 25 in the wall 21 in such a way that the flange 24 abuts the wall 21 to support the drain tap 23. However, the cardboard wall 21 provides a rather weak support for the drain tap 23.

FIG. 8 shows the same cross-section as in FIG. 7. The drain tap 23 has now been mounted with a support unit 1 corresponding to the support unit 1 described in FIG. 4 and FIG. 5. As it can be seen, the U-shaped part 8 of the support unit 1 is inserted between the wall 21 of the bag-in-box liquid dispenser 20 and the flange 24 of the drain tap 23, whereby the support unit 1 provides an excellent support of the drain tap 23.

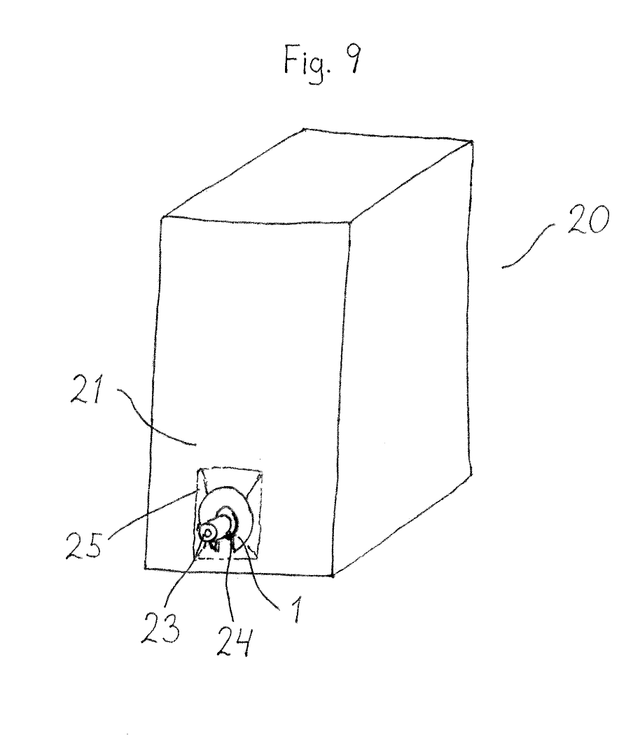

FIG. 9 shows a bag-in-box liquid dispenser 20 mounted with a support unit 1 on the drain tap 23. A part of the support unit 1 is inserted between the wall 21 of the box and the flange 24 of the drain tap 23. The cardboard wall 21 has an area 25 through which the drain tap 23 is lead. The area 25 is weakened due to the tearing to allow the drain tap 23 to pass through the cardboard wall 21 in this area and may not have sufficient strength to support the drain tap 23 without the assistance of the support unit 1.

As it can be understood, devices embodying principles of the present invention provide a highly advantageously solution for supporting the drain tap in a bag-in-box (BIB) liquid dispenser. The support unit is easy and convenient to use and provides and excellent support for the drain tap in a bag-in-box liquid dispenser. Although the invention has been described with reference to only a few embodiments it is to be understood that the invention comprises several other embodiments, which are all within the scope of the present invention.

While the invention has been described in detail with reference to exemplary embodiments thereof, it will be apparent to one skilled in the art that various changes can be made, and equivalents employed, without departing from the scope of the invention. The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

I claim:

1. A support unit for supporting a drain tap in a flexible bag located in a bag-in-box (BIB) liquid dispenser, the support unit comprising:
a plate having at least a substantially planar area with a least one surface adapted to abut the outer surface of the box, the substantially planar area facing a first direction;
a U-shaped slit in the plate configured and arranged to receive the drain tap when lead through the wall of the box and form a supporting collar around the drain tap;
wherein the plate comprises at least one convex area extending from the plate and facing in a second direction opposite from said first direction.

2. A support unit according to claim 1, wherein at least a part of an outer edge of the support unit is curved.

3. A support unit according to claim 1, wherein:
the U-shaped slit has an opening; and
the plate area next to the U-shaped slit tapers towards the opening of the U-shaped slit thereby forming two tapering areas on each side of the U-shaped slit.

4. A support unit according to claim 1, wherein the U-shaped slit has a rounded part adapted to engage with the drain tap.

5. A support unit according to claim 1, wherein at least a part of the area with a substantially flat surface surrounds the U-shaped slit.

6. A support unit according to claim 1, wherein at least a part of the area with a substantially flat surface is U-shaped.

7. A support unit according to claim 1, wherein the at least one convex area extends around the U-shaped slit.

8. A support unit according to claim 1, wherein the at least one convex area extends around at least a part of the area with a substantially flat surface and the U-shaped slit.

9. A support unit according to claim 1, wherein a periphery of the support unit is adapted to abut the outer surface of the box.

10. A support unit according to claim 1, wherein the support unit has a substantially circular periphery.

11. A support unit according to claim 1, wherein at least a part of the convex area comprises supporting ridges.

12. A support unit according to claim 1, wherein the support unit is made from a rigid or semi-rigid material selected from the group consisting of plastic, aluminum, and stainless steel.

13. A bag-in-box liquid dispenser comprising:
a box with at least one opening;
a bag having a drain tap, the bag being located in the box with the drain tap extending through the at least one opening; and
a support unit positioned between the drain tap and the box.
